(19) United States
(12) Patent Application Publication
(10) Pub. No.: US 2005/0107927 A1
(43) Pub. Date: May 19, 2005

(54) Remote monitoring and control of a motorized vehicle

(76) Inventor: Michael Mavreas, (US)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 11/002,251

(22) Filed: Dec. 3, 2004

Related U.S. Application Data
(63) Continuation of application No. 10/003,786, filed on Nov. 15, 2001.

(51) Int. Cl. G06F 7/00

(52) U.S. Cl. 701/29; 701/35

(57) ABSTRACT

Remote monitoring and control of a motorized vehicle is performed using a communications and control hub connected directly to an onboard diagnostic port of the vehicle. An auxiliary onboard diagnostic port is provided to permit technicians to perform diagnostics on the vehicle. All vehicle monitoring and control is effected without an auxiliary wiring harness. The communications control hub is particularly useful for fleet management and dispatch systems.

### CROSS-REFERENCE TO RELATED APPLICATIONS

This is a Continuation of U.S. patent application Ser. No. 10/003,786 filed on Nov. 15, 2001 hereby incorporated by reference herein.

### MICROFICHE APPENDIX

Not applicable.

### TECHNICAL FIELD

This invention relates to the field of remote monitoring and control of motorized vehicles and, in particular, to a system for enabling motorized vehicle control, fleet management, and dispatch control using an interface with an onboard diagnostic port of a motorized vehicle.

### BACKGROUND OF THE INVENTION

The on-demand monitoring and tracking of motorized vehicles is greatly facilitated by computer systems and wireless communications over cellular or satellite networks. The number of tasks that may be performed with computerized equipment onboard a motorized vehicle has grown with the attendant technology. In particular, the provision of services to users of, and the tracking of, motorized vehicles is taught in U.S. Pat. No. 6,240,365, entitled AUTOMATED VEHICLE TRACKING AND SERVICE PROVISION SYSTEM, which issued to Bunn et al. on May 29, 2001. According to Bunn, a number of sensors and actuators of a vehicle, a global positioning system (GPS) sensor, an interface with a cellular phone network, and a user interface, are controlled by a processor in the vehicle.

The context chosen to illustrate Bunn's system involves a fleet of rental vehicles. The sensors and actuators are accordingly used to non-intrusively report status and position of the vehicle to a headquarters, and to enable service features to a user of the vehicle. In particular the non-intrusive monitoring of vehicle damage using a plurality of motion and impact sensors, and the facilitation of messaging and communication services for the user, are effected in accordance with Bunn et al. Non-intrusive interrogation of the vehicle is also performed at the headquarters to ensure the safe condition and operation of the vehicle, and improve the safety for the user. If needed, a voice synthesizer component of the user interface is activated to warn the vehicle user of potential problems. Bunn's invention further provides the headquarters with an ability to disable or enable the ignition of the vehicle and to access a plurality of sensors and actuators connected to the processor.

Because of the nature of the control and monitoring Bunn implements, and difficulties associated with accessing a vehicle data communications bus installed on respective motorized vehicles, Bunn provides a secondary wiring harness to directly interconnect the processor with selected vehicle devices, and systems that Bunn desires to control. Consequently, each new vehicle added to the fleet must be retrofitted with the secondary wiring harness, as well as a plurality of sensors and actuators. As is well known in the art, such retrofits are time-consuming and expensive, even if a relatively small number of sensors and actuators are used.

Installing, troubleshooting and removing the fleet tracking and service provision system is made difficult by the inclusion of the secondary wiring harness. As many fleet managers prefer to use a vehicle for only a part of the vehicle's service life, removal is desirable. Removal of the fleet tracking and service provision system is time-consuming and likely leaves at least parts of the secondary wiring harness in the vehicle. Furthermore, the adaptation of the devices for joint control over particular vehicle units may lead to problems in maintaining and troubleshooting the original equipment wiring harness for the vehicle's data communications bus.

Problems associated with after-market over-wiring of a security system for enabling secondary control and monitoring of vehicle devices are recognized by Kenneth E. Flick in U.S. Pat. No. 6,243,004, entitled VEHICLE SECURITY SYSTEM WITH INDUCTIVE COUPLING TO A VEHICLE HAVING A DATA COMMUNICATIONS BUS AND RELATED METHODS, which issued on Jun. 5, 2001. According to Flick, a security system can control and monitor systems and devices interconnected by the vehicle's data communications bus. The devices in the vehicle are monitored and controlled indirectly via inductive couplings to the vehicle's data communications bus. Installation and removal is complicated by the fact that a plurality of inductive couplings may be required, one for each vehicle sub-system. Consequently the inductive couplings must be strategically placed, which requires skilled installation technicians with detailed knowledge of the structure of the vehicle's data communications bus. Moreover as manufacturers generally make changes to vehicle data communications buses on each new model year, substantial revision to Flick's system may be required each year, which likewise increases the cost and the need for skilled labor.

A gateway for interfacing a vehicle's data communications bus with an “intelligent transport system” data bus (IDB) is explained in Automotive Multimedia Interface Collaboration's “OEM to IDB-C Gateway Specification” 3003-0-0. This document describes a means for integrating a vehicle's data communications bus with the IDB, which can be used for communications, entertainment, navigation, etc. The gateway is not intended to facilitate control of core vehicle functions, but does enable access to central vehicle functions in order to enhance communications and entertainment using devices connected to the vehicle's data communications bus. A separate gateway for accessing the vehicle's data communications bus leaves a diagnostic port for use by service technicians. The devices, systems and functions fleet managers need to control and monitor, may not all be supported by the gateway. Moreover most existing fleet vehicles do not include such a gateway, and retrofitting vehicles is costly and complicated.

It is also known in the art to use computerized equipment for accessing an onboard diagnostic interface in order to receive status information from the onboard diagnostic system, and to provide control over non-critical vehicle systems. U.S. Pat. No. 6,202,008 entitled VEHICLE COMPUTER SYSTEM WITH WIRELESS INTERNET CONNECTION, which issued to Beckert et al. on Mar. 13, 2001, teaches that a computer system for a vehicle can be connected to an onboard diagnostic system interface in some undisclosed manner. The onboard diagnostic system interface is one of a plurality of peripheral devices adapted to connect to a USB hub, which is connected with the computer system. The purpose of Beckert's system is to enable a person in the motorized vehicle to access computer functionality of numerous systems often found in motorized vehicles, through a single presentation module. The computer system executes communications, entertainment, security, and vehicle diagnostic applications. To enhance functionality, the system is interconnected with the Internet via wireless communication.

While it is evident that the value of enabling motorized vehicle control, fleet management and dispatch has been recognized, the systems for enabling fleet management have required modification in one form or another of individual motorized vehicles in the fleet. This impedes the process of bringing a new vehicle into the fleet and increases startup costs. Furthermore, when a vehicle is removed from the fleet, the modifications are preferably reversed or restored, which likewise delays the process and contributes to expenses.

There therefore exists a need for an apparatus for enabling a system for managing a fleet of motorized vehicles that may be installed at minimal cost and effort by avoiding a reliance upon auxiliary wiring.

### SUMMARY OF THE INVENTION

It is therefore an object of the invention to provide an apparatus for enabling monitoring and control of a motorized vehicle without auxiliary wiring.

It is another object of the invention to provide an apparatus that is adapted to access an extensible set of functions supported by a vehicle processor network on the motorized vehicle, so that the apparatus supports a flexible set of procedures that are exercised through the diagnostic port of the vehicle processor network.

Accordingly, a communications and control hub is provided that is adapted to interface with a vehicle processor network of a motorized vehicle through an onboard diagnostic port of the motorized vehicle. All vehicle functions and devices are monitored and controlled through the onboard diagnostic port. A need for an auxiliary wiring harness is therefore avoided. An auxiliary onboard diagnostic port connector is provided for use by service technicians for servicing the motorized vehicle without disconnecting the communications and control hub. The auxiliary onboard diagnostic port connector may be provided on the communications and control hub, or it may be connected to an auxiliary cable integrated with a cable used to interconnect the onboard diagnostic port and the communications and control hub. Substantially any arrangement for coupling the communications and control hub with the onboard diagnostic port that provides an auxiliary onboard diagnostic port connector is acceptable for the purposes of the present invention.

The communications and control hub is preferably in wireless communications with a system for managing motorized vehicles of a fleet. This permits the system for managing to access the vehicle processor network of the motorized vehicle on demand. A processor of the communications and control hub is adapted to control message exchanges with the vehicle processor network and to support wireless communications. The wireless communications may be cellular telephone or satellite communications. The system for managing may be accessed via a 10baseT Ethernet connection via satellite, for example.

The communications and control hub may further be adapted to interface with a global positioning service (GPS) sensor, which provides location information to the communications and control hub. The location information may then be forwarded to the system for managing, on request, or in accordance with a predetermined schedule. Additionally, a plurality of sensors and actuators may be connected to the processor. These may vary widely with the fleet to be managed. A refrigerated truck may include sensors for the climate of the cargo unit, for example. A number of ports on the communications and control hub may be provided for respective sensors, actuators, or sensor and actuator systems. The sensors and actuators may relate to a condition of an operator of the motorized vehicle, a condition of a person or object carried in, or connected to, the motorized vehicle, and generally a condition of an environment, system, device or entity within, connected to, or around the motorized vehicle that is not accessible from the vehicle processor network. The ports may conveniently be standard communications ports for digital signaling. The ports may also be preselected for particular signaling protocols. The communications and control hub is preferably adapted to send information received from any of its ports to the system for managing, via the transceiver.

Also in accordance with the invention, a method and system for managing and/or dispatching a fleet of motorized vehicles are provided. The method involves using a communications and control hub to interface with the vehicle processor network of the motorized vehicle through the onboard diagnostic port of the motorized vehicle. The interface with the vehicle processor network permits the communications and control hub to monitor vehicle functions and control states of a plurality of devices on the vehicle processor network. The information is used by fleet managers and/or dispatchers to improve fleet management and dispatch functionality.

### BRIEF DESCRIPTION OF TEE DRAWINGS

Further features and advantages of the present invention will become apparent from the following detailed description, taken in combination with the appended drawings, in which:

FIG. 1 is a schematic diagram of a prior art system for managing a fleet of motorized vehicles;

FIG. 2 is a schematic diagram of a communications and control hub in accordance with the invention interconnected with a diagnostic port of a vehicle processor network and a plurality of external devices;

FIG. 3 is a schematic diagram of port connections of a communications and control hub in accordance with one embodiment of the invention; and

FIG. 4 is a schematic diagram of port connections of a communications and control hub in accordance with another embodiment of the invention.

It should be noted that throughout the appended drawings, like features are identified by like reference numerals.

### DETAILED DESCRIPTION OF THE PREFERRED EMBODIMENT

The invention relates to a method and system for monitoring and controlling a motorized vehicle. The system is quickly and inexpensively installed in or removed from the motorized vehicle, facilitates updates or upgrades to enable access to any function or device on a vehicle processor network of the motorized vehicle.

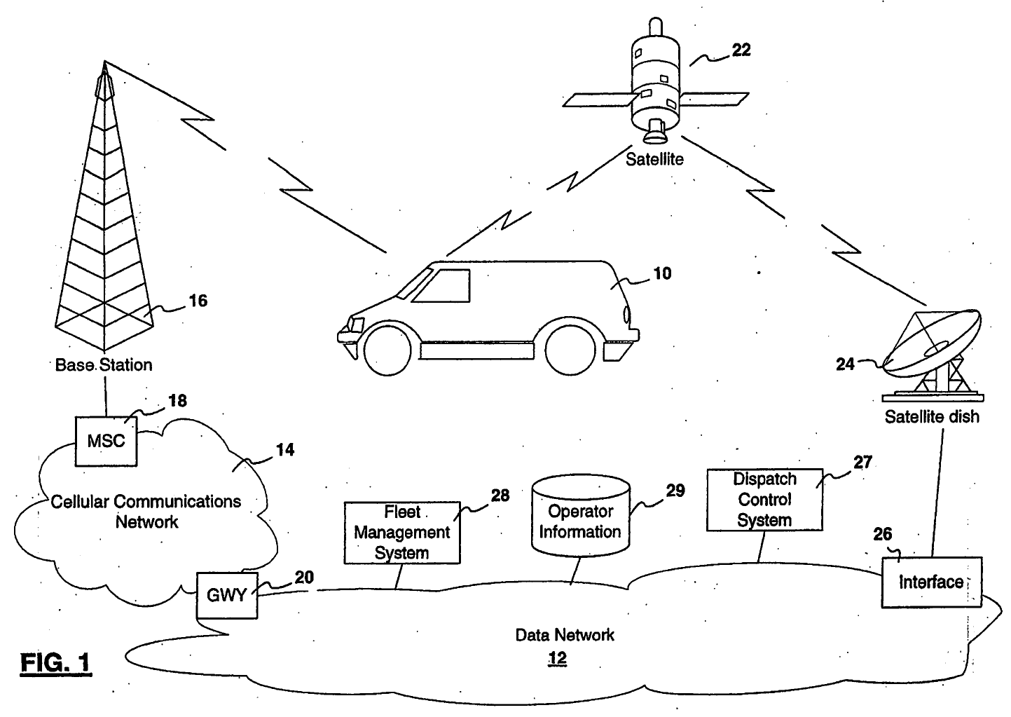

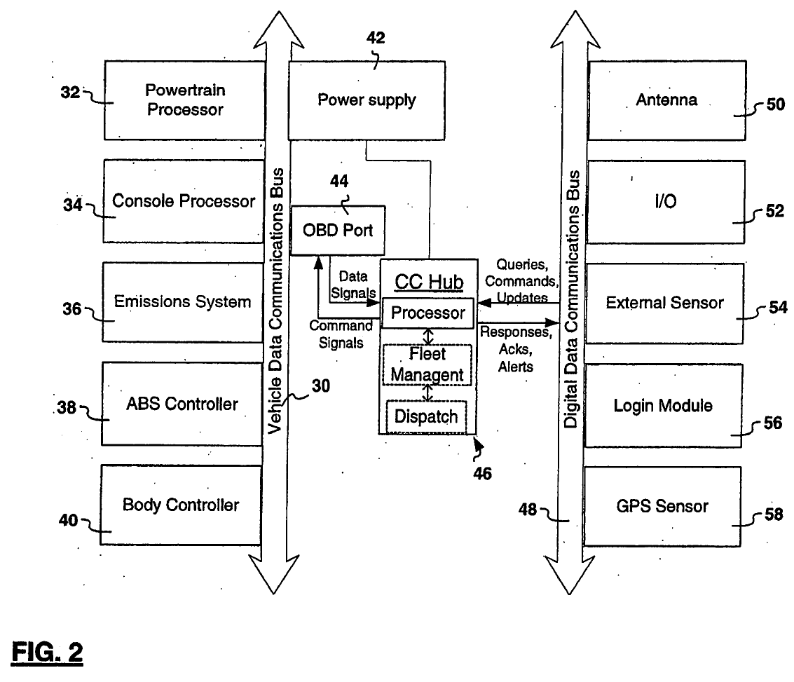

FIG. 1 is a schematic diagram of elements of an embodiment of a system in accordance with the invention. A motorized vehicle 10 equipped with a communications and control hub that supports wireless communications is, for example, a part of a fleet of motorized vehicles. The communications and control hub, which will be described below with reference to FIG. 2, is in wireless communications with a data network 12 through either or both of a satellite communications system and a cellular communications network 14. The cellular communications network 14 includes a plurality of base stations 16 (one illustrated) that exchange radio frequency signals with cellular communications users, including the communications and control hub of the motorized vehicle 10. The radio frequency signals exchanged through the base station 16 are converted to/from electrical signals conveyed to/from a mobile switching center (MSC) 18. The MSC 18 effects switching of voice and data traffic to a public switched telephone network (PSTN) that supports interfaces with a number of other networks and peripherals. A gateway 20 to the data network 12 (which may be an Internet protocol network) serves to interconnect the cellular communications network 14 with the data network 12.

A second means for wireless communications is the satellite communications system. A satellite 22 exchanges radio frequency signals with the communications and control hub in the motorized vehicle 10. A ground station with a satellite dish converts the exchanged signals to/from an electrical format. An interface 26 converts electrical signals into predetermined messaging protocol.

The data network 12 supports communications between the gateway 20 and/or interface 26 and a dispatch control system 27 and/or a fleet management system 28. The dispatch control system is operated by dispatch controllers in a manner well known in the art. In accordance with the invention, dispatch controllers use vehicle status and location data to improve the dispatch process. In addition, the dispatch control system preferably also improves the dispatch process by utilizing operator information stored in an operator information database 29. The operator information may include, for example, information about operator driving records, expertise, experience, and/or other work metrics.

The fleet management system is operated by fleet managers, also in a manner well known in the art. In accordance with the invention, fleet management operators use vehicle status and location information to improve the fleet management process. In addition, the fleet managers may use vehicle operator information to further improve the fleet management process. The operator information database preferably stores vehicle operator summaries for vehicle operators which may be analyzed to determine problem areas and screen out poor operators, or the like.

FIG. 2 is a schematic diagram of an onboard communications and vehicle function control system in accordance with the invention for the motorized vehicle 10. As is known in the art, in the past few years, motorized vehicles have been equipped with vehicle data communications busses installed by respective manufacturers. The vehicle data communications busses interface with a plurality of devices and systems that communicate for many purposes related to the states and activities of the various devices and systems. As illustrated, a vehicle data communications bus 30 enables communication between a powertrain processor 32, a console processor 34, a system for sensing and controlling emissions 36, an antilock braking system (ABS) controller 38, and a body controller 40. The messaging supported by the vehicle data communications bus 30 is used to: dynamically optimize engine performance; enable the console to serve as an interface between the user and various displayed states of devices and systems; monitor emissions of the motorized vehicle 10; etc. The power to the electrical system is governed by a power supply 42 that is connected to a battery of the motorized vehicle 10, and supplies power to a plurality of devices requiring electrical power. An interface with the vehicle data communications bus 30 is provided by an onboard diagnostic port 44, which is intended for use by technicians to obtain trouble codes associated with various aspects of the operation of the motorized vehicle 10. In accordance with the present invention, however, the onboard diagnostic port 44 is directly connected to a communications and control hub 46 to provide an interface with the vehicle processor network, which includes the vehicle data communications bus 30 and the plurality of devices and systems 32-40. It will be understood by those skilled in the art that numerous other devices and systems (usually referred to as nodes) can be interconnected by the vehicle data communications bus 30, including a transmission controller, an airbag controller, an anti-theft system, a temperature controller, a trip computer, an instrument cluster controller, and an active suspension controller The connection to the onboard diagnostic port provides access for a processor in the communications and control hub 46 to all data signals exchanged on the vehicle communications data bus 30. The onboard diagnostic port 44 also enables the processor to send command signals over the vehicle data communications bus to any one of the processors or controllers 32-40, in order to control operations of the motorized vehicle 10, as required.

The communications and control hub 46 is powered by the power supply 42, and also interfaces with a digital data communications bus 48 for communicating with a plurality of external devices. The external devices include, for example, means for wireless communication, such as an antenna 50, with the system 28 for managing a fleet. The system for managing 28 accesses the vehicle processor network by sending query messages or commands through the data network 12. The system for managing a fleet 28 in accordance with the invention may perform, for example: instant two-way messaging and message logging, route management, automated scheduled maintenance, work metrics associated with a driver of the motorized vehicle 10, vehicle alert notification, vehicle data logging, vehicle services, and vehicle security. Work metrics involve recording the use of the motorized vehicle 10, and may include analysis of how long the motorized vehicle 10 has remained continuously in an idle state, a frequency of revolution of the engine, rates of acceleration and deceleration, how often the driver signals before turning; all of which may indicate the driving practices of the user of the motorized vehicle 10. Vehicle services may include remote locking/unlocking, ignition control, and climate control.

The external devices interconnected by the digital data communications bus 48 also preferably includes an input/output (I/O) with a user interface 52. This I/O 52 with the user interface provides a connection for a visual display (monitor), a keyboard and/or mouse. An operator of the motorized vehicle 10, and/or a passenger may use devices connected to the I/O 52 for purposes of: communications, dispatch, or any other purpose specific to the use of the motorized vehicle. Specifically, the I/O 52 is used to receive dispatch messages, to request and receive routing instructions, to report, or obtain a forecast of weather, traffic, or road conditions, and to manually report status of the motorized vehicle, cargo, passenger, or transported item, or any other work-related data.

An external sensor port 54 is connected to the digital data communications bus 48 to permit external sensors to be used in the vehicle, if required. The external sensor port 54 can be used to monitor any one or more of: a condition of an operator of the motorized vehicle; a condition of a person or object carried in, or connected to, the motorized vehicle; and a condition of an environment, system, device or entity within or surrounding the motorized vehicle that is not accessible from the vehicle processor network. Examples of external sensors include smoke or alcohol detectors; a passenger seat occupancy detector; a motion detector or a temperature sensor in a cargo hold; a proximity sensor, a cargo door state sensor; or the like.

A login module 56 provides a means for tracking users of the motorized vehicle 10, particularly so that a work metrics application can track the same user on a plurality of motorized vehicles in the fleet. The login module 56 is further used to enable secure authorization to fleet drivers. Failed authentication at the login module 56 may deactivate the ignition, even with a key to the motorized vehicle 10 by sending appropriate command signals from the communications and control hub 46 to the powertrain processor 32. The login module 56 may, in other embodiments, be incorporated into an I/O interface, such as I/O 52, however it is assumed that the login module 56 is an external unit that incorporates a biometric scanner. The login module 56 uses a biometric feature, such as a fingerprint, to authenticate operators of the motorized vehicle 10, prior to enabling ignition. The login module may, for example, require operator authentication each time An operator leaves his seat, shuts off the vehicle, or otherwise sends an indication that the operator may have changed. If operator authentication is required, the communications and control hub 46 preferably sends command signals over the vehicle data communications bus 30 to the powertrain processor 32 to disable operation of the vehicle, such as deactivating the ignition system and locking the brakes, or the like.

A global positioning system (GPS) sensor 58 is also provided. The GPS sensor 58 permits the system to create and maintain records of a location of the motorized vehicle 10, as is known in the art. Output of the GPS sensor 58 may be used for security, route management and dispatch applications.

In accordance with another aspect of the invention, the processor in the communications and control hub 46 is adapted to perform message format and protocol conversion, as required, between messages sent over the vehicle data communications bus 30 and messages sent over the digital data communications bus 48. The processor is adapted to run a program used to monitor vehicle function and control devices connected to the vehicle data communications bus 30. The program also monitors and controls one or more external sensors, (i.e. the GPS sensor 58 and sensor(s) connected to the external sensor interface 54). The processor also provides a user interface to the operator of the motorized vehicle 10. The processor therefore enables the display of information, the receipt of information and commands from the operator, and communications between the operator in the motorized vehicle 10 and other systems available on the data network 12. The processor is therefore responsible for issuing messages to, and receiving messages from, the data network 12. Important to the flexibility of the application in accordance with the invention is the ability to download new program updates or upgrades, as well as operating systems and messaging protocol information, from the data network 12, through wireless communications links. This enables the processor of the communications and control hub 46 to effect new operation routines as they become available. Moreover this enables an update of a fleet of motorized vehicles with minimal time, effort and expense.

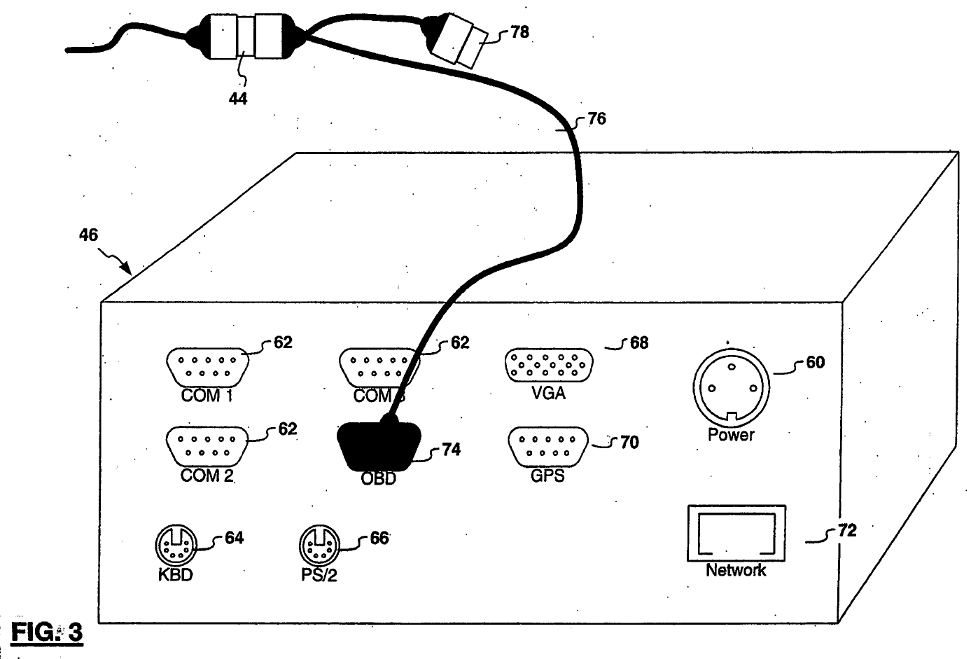

FIG. 3 is a schematic diagram of port connections on a communications and control hub 46, in accordance with one embodiment of the invention. The communications and control hub 46 includes a plurality of connectors, including: a power supply connector 60; three communications ports 62; two PS/2 ports, one for a keyboard 64, the other for a mouse 66; a connection for a monitor 68; a communications port reserved for a GPS sensor 70, a network communications port 72, and an onboard diagnostic port connector 74.

The two PS/2 ports 64,66 and the monitor connector 68 serve the I/O user interface 52. Other embodiments may incorporate a voice interface, which may be effected using a voice synthesizer and voice recognition software. The voice interface is enabled using a speaker and/or microphone system of the motorized vehicle 10, accessed through the onboard diagnostic port 44. A further aspect of the I/O 52 may be supported by a system for projecting images onto a windshield of the motorized vehicle 10.

The three illustrated communications ports 62 and the GPS sensor port 70 support digital communications to control and monitor respective systems, actuators or sensors. In the embodiment schematically illustrated in FIG. 2, the external sensor 54 is connected to one of the communications ports 62, and the GPS sensor 58 is connected to the GPS sensor port 70. The communications and control hub 46 therefore supports another two sensors, actuators or sensor-actuator systems.

The network communications port 72 is connected to the antenna 50. It may be, for instance, a 10baseT Ethernet port for signaling over a satellite communications network, as illustrated. In other embodiments, the network communications port 72 may be to a modem, for data exchange over the cellular communications network 14.

The onboard diagnostic port connector 74 is connected to the onboard diagnostic port 44 by a cable 76. The cable 76 includes an auxiliary onboard diagnostic port connector 78, which makes the onboard diagnostic port 44 available to service technicians. This permits the communications and control hub 46 to be connected to the vehicle communications bus 30 (FIG. 2) in a matter of seconds. No auxiliary wiring is required to monitor and control vehicle function, because all vehicle monitoring and control functions are effected through the vehicle diagnostic port 44 using an appropriate protocol, well known in the art. Every monitoring signal available on the vehicle data communications bus can be monitored, recorded and/or reported by the communications and control hub 46. Likewise, any vehicle function for which control codes are available can be controlled by the communications and control hub 46, under the direction of an operator of the fleet management system 28, an operator of the dispatch control system 27, or under direct control by the communications and control hub 46. Likewise, when a vehicle is retired from the fleet, the communications and control hub 46 is readily disconnected and removed from the vehicle without leaving behind any auxiliary wiring or other artifacts that could affect resale value of the vehicle.

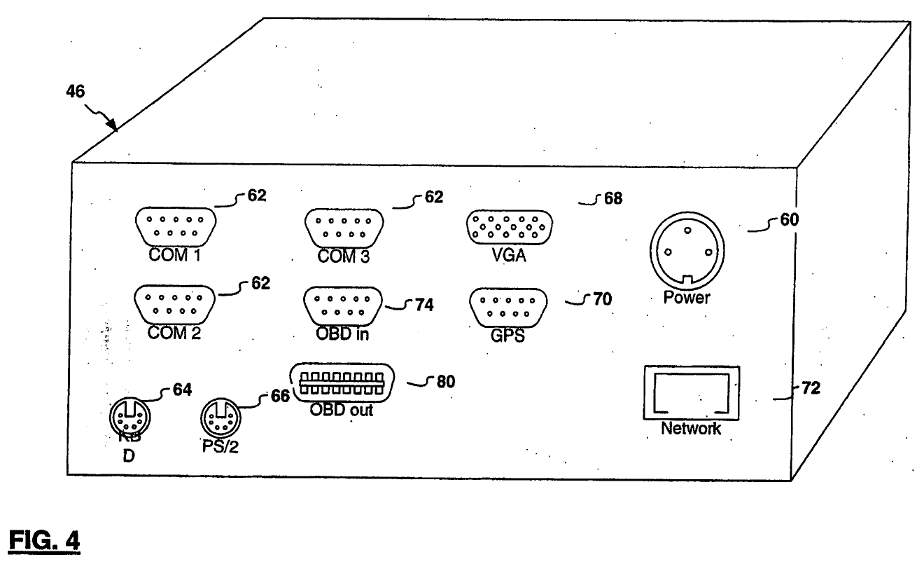

FIG. 4 is a schematic diagram of port connections featured on a communications and control hub 46, in accordance with another embodiment of the invention. The communications and control hub 46 comprises the same plurality of connectors as illustrated in FIG. 2, and further includes an auxiliary onboard diagnostic port connector 80. There are numerous viable implementations allowing the communications and control hub 46 to be connected to the onboard diagnostic port 44, while permitting access to the onboard diagnostic port 44, or an auxiliary onboard diagnostic port connector 78,80 for other purposes.

The embodiments of the invention described above are therefore intended to be exemplary only. The scope of the invention is intended to be limited solely by the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method, comprising:
using a login module to authenticate an operator of a vehicle; and
using a communications and control hub connected to the login module to activate an ignition of the vehicle by sending a command signal to a powertrain processor of the vehicle via a vehicle data communications bus if the operator is authenticated.

22. The method defined in claim 21, further comprising:
deactivating the ignition of the vehicle each time an indication is received that an operator of the vehicle may have changed.

23. The method defined in claim 21, further comprising:
acquiring an enable signal from the login module; and
activating the ignition when the enable signal is received.

24. The method defined in claim 23, wherein the login module performs steps of:
acquiring a scan of a biometric feature of the operator of the motorized vehicle; and
comparing the scan with stored information using a predetermined comparison algorithm to determine whether the enable signal should be sent.

25. A login module for connection to a communications and control hub in a vehicle, comprising:
means for receiving input from a potential operator of the vehicle;
means for authenticating the potential operator of the vehicle on a basis of the input and, responsive to successful authentication of the potential operator of the vehicle, causing the communications and control hub to send a command signal instrumental in enabling a vehicle function.

26. The login module defined in claim 25, wherein the means for receiving input comprises a biometric scanner.

27. The login module defined in claim 26, wherein the input is a biometric feature.

28. The login module defined in claim 25, wherein the vehicle function is at least one of a vehicle ignition and an ability to unlock vehicle brakes.

29. In combination:
a communications and control hub having control over a function of a vehicle;
a login module connected to the communications and control hub, the login module adapted for:
authenticating a potential operator of the vehicle; and
responsive to successful authentication of the potential operator of the vehicle, causing the communications and control hub to send a signal instrumental in enabling the vehicle function.

30. The combination defined in claim 29, further comprising:
an external sensor connected to the communications and control hub, the external sensor comprising means for monitoring a condition of the vehicle to generate an indication of a suspected presence of the potential operator of the vehicle and providing said indication to the communications and control hub;
wherein the communications and control hub comprises means responsive to said indication, for determining whether authentication is required and disabling the vehicle function in response to determining that authentication is required.

31. The combination defined in claim 30, wherein the external sensor is at least one of a proximity sensor, a seat occupancy detector and a motion detector.

32. The combination defined in claim 30, wherein the vehicle function is at least one of a vehicle ignition and an ability to unlock vehicle brakes.

33. A method of controlling a vehicle function, comprising:
using a login module to perform authentication of a potential operator of the vehicle;
responsive to successful authentication of the potential operator of the vehicle, enabling the vehicle function.

34. The method defined in claim 33, wherein the vehicle function is at least one of a vehicle ignition and an ability to unlock vehicle brakes.

35. The method defined in claim 33, wherein performing authentication of the potential operator of the vehicle comprises receiving a biometric feature input by the potential operator of the vehicle via a biometric scanner in the vehicle.

36. The method defined in claim 33, further comprising:
monitoring a condition of the vehicle to generate an indication of a suspected presence of the potential operator of the vehicle;
wherein the step of performing authentication of the potential operator of the vehicle is performed in response to said indication.

37. The method defined in claim 36, wherein the vehicle function is at least one of a vehicle ignition and an ability to unlock vehicle brakes.

38. The method defined in claim 36, wherein the condition of the vehicle is an output of at least one of a seat occupancy detector, a motion sensor and a proximity detector in the vehicle.

39. The method defined in claim 33, further comprising prior steps of:
monitoring a condition of the vehicle to generate an indication of a suspected presence of the potential operator of the vehicle;
responsive to said indication, determining whether authentication is required;
responsive to authentication being required, disabling the vehicle function.

40. The method defined in claim 39, wherein the vehicle function is at least one of a vehicle ignition and an ability to unlock vehicle brakes.

41. The method defined in claim 39, wherein the condition of the vehicle is an output of at least one of a seat occupancy detector, a motion sensor and a proximity detector in the vehicle.

42. The method defined in claim 33, further comprising a prior step of disabling the vehicle function.

43. The method defined in claim 33, further comprising:
responsive to failed authentication of the potential operator of the vehicle, keeping the vehicle function disabled.

44. The method defined in claim 43, wherein the vehicle function is at least one of a vehicle ignition and an ability to unlock vehicle brakes.

45. A method of controlling a currently enabled function of a vehicle operated by an operator, comprising:
monitoring a condition of the vehicle to generate an indication of a potential change in vehicle operator;
responsive to said indication, disabling the vehicle function.

46. The method defined in claim 45, wherein the vehicle function is at least one of a vehicle ignition and an ability to unlock vehicle brakes.

47. The method defined in claim 45, wherein the condition of the vehicle is an output of at least one of a seat occupancy detector, a motion sensor and a proximity detector in the vehicle.

48. The method defined in claim 45, the condition of the vehicle being a first condition, the method further comprising:
monitoring a second condition of the vehicle to generate an indication of a new potential vehicle operator;
performing authentication of the new potential vehicle operator;
responsive to successful authentication of the new potential vehicle operator, enabling the vehicle function.

49. The method defined in claim 48, wherein the vehicle function is at least one of a vehicle ignition and an ability to unlock vehicle brakes.

50. The method defined in claim 48, further comprising:
responsive to failed authentication of the potential new vehicle operator, keeping the vehicle function disabled.
